(19) United States
(12) Patent Application Publication
(10) Pub. No.: US 2005/0146844 A1
(43) Pub. Date: Jul. 7, 2005

(54) Mounting kit for releasably securing portable video player device and/or detachable display unit to vehicle seat

(76) Inventors: Saied Hussaini, (US); Marc Iacovelli, (US)

Correspondence Address: LINIAK, BERENATO & WHITE;Suite 240, 6550 Rock Spring Drive, Bethesda, MD, 20817, US

(21) Appl. No.: 10/961,378

(22) Filed: Oct. 12, 2004

Related U.S. Application Data
(60) Provisional application No. 60/509,918, filed on Oct. 10, 2003.

(51) Int. Cl. G06F 1/16

(52) U.S. Cl. 361/681

(57) ABSTRACT

A mounting kit comprises a player mounting system provided for carrying and removably attaching a video player device to a vehicle seat, and a display harness system for carrying and removably mounting a video display unit to the vehicle seat independent of the video player device. The display harness system includes a display case provided for housing the video display member within the display case and a mounting strap attached to the display case for removably attaching the display case to the vehicle seat. A bottom side of said display case defines an opening provided for receiving the video display member of the display unit within the display casing. The display case further has a retainer provided for releasably securing the video display member within the display case so that the base member of the video display unit extends from the display case.

### CROSS-REFERENCE TO RELATED APPLICATION

This Application claims the benefit under 35 U.S.C. 119(e) of U.S. Provisional Application No. 60/509,918 filed Oct. 10, 2003 by S. Hussaini et al and is incorporated herein by reference.

### BACKGROUND OF THE INVENTION

1. Field of the Invention

The present invention relates to use of consumer electronics in a vehicle in general, and more particularly to a mounting kit for releasably securing a display device and an electronic signal generating device to a seat of the vehicle.

2. Description of the Prior Art

Video entertainment devices are becoming increasingly popular. VCRs, DVDs, and similar electronic devices are commonly found in most households today, particularly households having young children and teenagers. These devices generally have a box-shaped housing with a plurality of plugs for interfacing with multiple complementary devices. Typically, these electronic devices do not have a dedicated video display screen, and are adapted to work with conventional TV monitors. Thus the portability of these devices is often limited to the video display device to which they are connected. Moreover, most households have a limited number of televisions, and when one family member uses the television as a video display device, other family members are unable to watch conventional televised entertainment. Thus there is a need for a compact, detachable, portable video display device adapted to be used with electronic video-processing devices. Such a need particularly exists for video players, such as the DVD or VCD players and VCRs.

Moreover, to take advantage of the advances in technology that enables DVD players and other electronic equipment, to be completely portable, various portable electronics carrying systems have been developed. These systems include bags and cases for transport by individuals, and carrying systems for use in automobiles. Typical examples of backpack-type systems include: U.S. Pat. No. 6,393,745 to Miki; U.S. Patent Application Publications U.S. 2003/0029755 to Ho; and U.S. 2002/0088726 to Chou; each of which are hereby incorporated by reference. Typical examples of systems for automobiles include U.S. Patent Application U.S. 2002/0105507 to Tranchina, and U.S. Pat. No. 6,097,448 to Perkins, U.S. Pat. No. 5,842,715 to Jones, and U.S. Pat. No. 5,395,023 to Naymark, U.S. 2001/0011664 A1 to Meriot each of which are hereby incorporated by reference.

Although the prior art includes a wide variety of transport methods, the referenced systems are generally overly complex, and/or do not provide adequate support for the portable electronic equipment, particularly in an automobile. The present invention improves upon the drawback of the prior art providing a convenient mechanism to secure a portable electronic device and a video display unit independent of the portable electronic device to a vehicle seat without the necessity for connection to additional portions of the vehicle.

### SUMMARY OF THE INVENTION

The present invention is a mounting kit for removably securing a portable video player device, such as DVD player, and/or a video display unit to a vehicle seat.

The video display unit of the present invention is detachably mounted to the video player device. In the preferred embodiment, the video display unit comprises video display member including a viewing surface provided with a display screen, and a base member pivotally mounted to the video display member. In turn, the video player device includes a player casing provided with at least one display support slot formed thereon. The base member is disposed within the at least one display support slot of the player casing thereby forming a selectively releasable connection between the player casing and the video display panel. Furthermore, a rear panel of the video player device is provided with a release lever including a locking tab that engages a complementary recess formed in the base member of the video display unit to positively connect the video player device to the base member of the video display unit. Preferably, the release lever is formed as a flexible cantilever formed.

The display harness system includes a display case provided for housing the video display member within the display case and a mounting strap attached to the display case for removably attaching the display case to the vehicle seat.

The display case has a front side, a rear side, and a bottom side. The bottom side of said display case defines an opening provided for receiving the video display member of the display unit within the display casing. The display case further has a retainer provided for releasably securing the video display member within the display case so that the base member of the video display unit extends from the display case.

### BRIEF DESCRIPTION OF THE DRAWINGS

The objects and advantages of the invention will become apparent from a study of the following specification when viewed in light of the accompanying drawings, wherein:

FIG. 1 is a perspective view of a video display unit attached to a separate video player device in a deployed position;

FIG. 2 is a perspective view of the video display unit attached to the separate video player device in a stowed position;

FIG. 3 is a perspective view of the video player device;

FIG. 4 is a right side view of the video player device;

FIG. 5 is a left side view of the video player device;

FIG. 6 is a top view of the video player device;

FIG. 7 is a perspective view of the video display unit;

FIG. 8 is a front view of a stand portion of a base member of the video display unit;

FIG. 9 is a side view of the stand portion of a base member of the video display unit;

FIG. 10 is a front view of a video display member of the video display unit;

FIG. 11 is a rear view of the video display unit attached to the separate video player device in a stowed position;

FIG. 12 is a cross-sectional view as seen from the plane indicated by the line A-A in FIG. 11;

FIG. 13 is an enlarged partial sectional view of a latch mechanism shown in a circle “B” in FIG. 12;

FIG. 14 is a perspective view of the video display unit separated from the video player device;

FIG. 15 is a perspective view of the video display unit removed from the video player device and independently supported on a flat surface;

FIG. 16 is an isolated perspective view of a player mounting system of a mounting kit according to the preferred embodiment of the present invention;

FIG. 17 is a rear perspective view of the player mounting system secured to a vehicle seat;

FIG. 18 is a side view of the player mounting system depicted in FIG. 17;

FIG. 19 is a front perspective view of the vehicle seat with the player mounting system secured thereto;

FIG. 20A is a front perspective view of a display harness system of the mounting kit according to the preferred embodiment of the present invention;

FIG. 20B is a rear perspective view of the display harness system of the mounting kit according to the preferred embodiment of the present invention;

FIG. 21 is a front view of the display harness system depicted in FIG. 20;

FIG. 22 is a rear view of the display harness system depicted in FIG. 20;

FIG. 23 is a right side view of the display harness system depicted in FIG. 20;

FIG. 24 is a left side view of the display harness system depicted in FIG. 20;

FIG. 25 is a bottom view of the display harness system depicted in FIG. 20;

FIG. 26 is a top view of the display harness system depicted in FIG. 20;

FIG. 27 is a perspective view of the video display unit retained within the display harness system of the mounting kit according to the preferred embodiment of the present invention;

FIG. 28 is a front view of the video display unit retained within the display harness system of the mounting kit according to the preferred embodiment of the present invention.

### DETAILED DESCRIPTION OF PREFERRED EMBODIMENTS

The preferred embodiment of a present invention will now be described with the reference to accompanying drawings. For purposes of the following description, certain terminology is used in the following description for convenience only and is not limiting. The words “right”, “left”, “bottom” and “top” designate directions in the drawings to which reference is made. The words “inwardly” and “outwardly” refer to directions toward and away from, respectively, the geometric center of the present invention and designated parts thereof. However, it is to be understood that the invention may assume various alternative orientations, except where expressly specified to the contrary. The terminology includes the words specifically mentioned above, derivatives thereof and words of similar import.

It is also to be understood that the specific article illustrated in the attached drawings, and described in the following specification is simply exemplary embodiment of the inventive concept. Specific dimensions and other physical characteristics relating to the embodiment disclosed herein are not to be considered as limiting, unless expressly stated otherwise. Additionally, the word “a,” as used in the claims, means “at least one.”

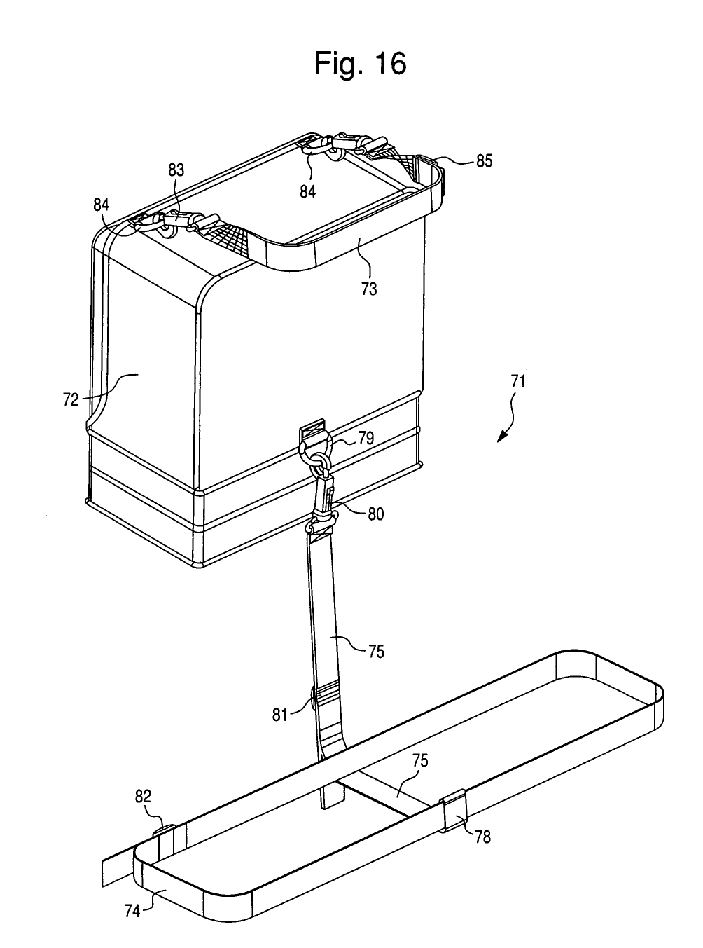

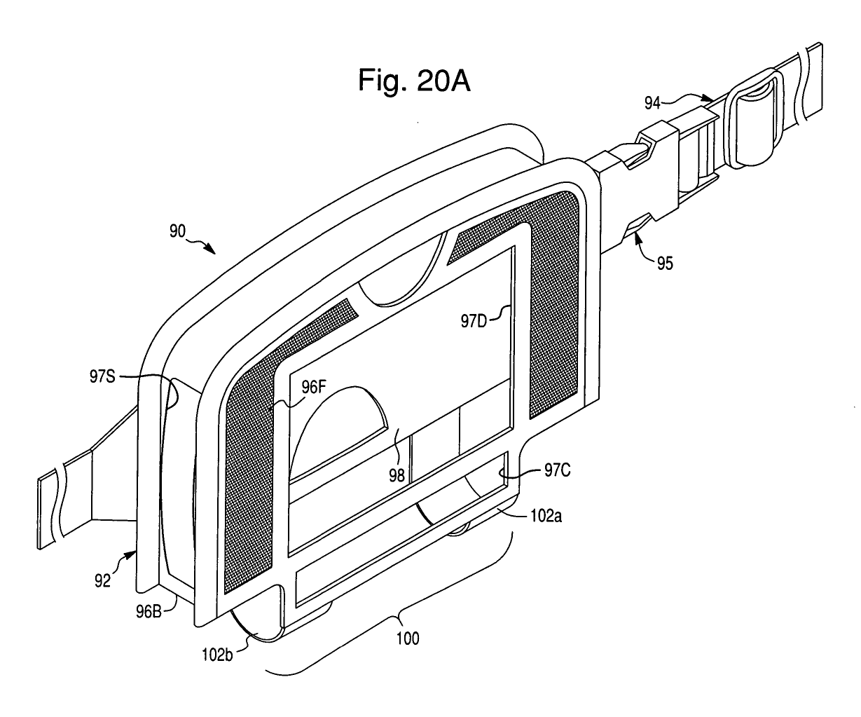

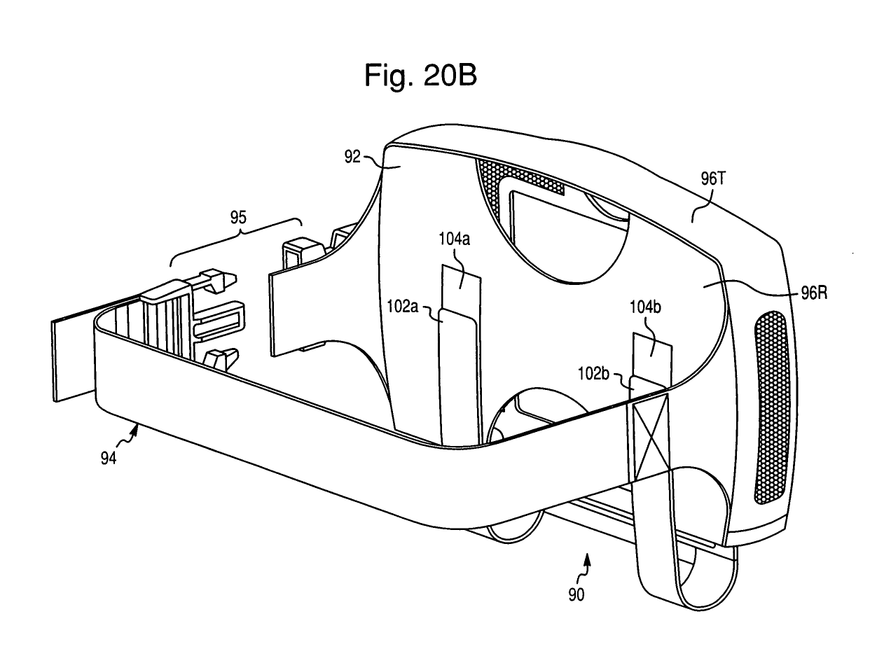

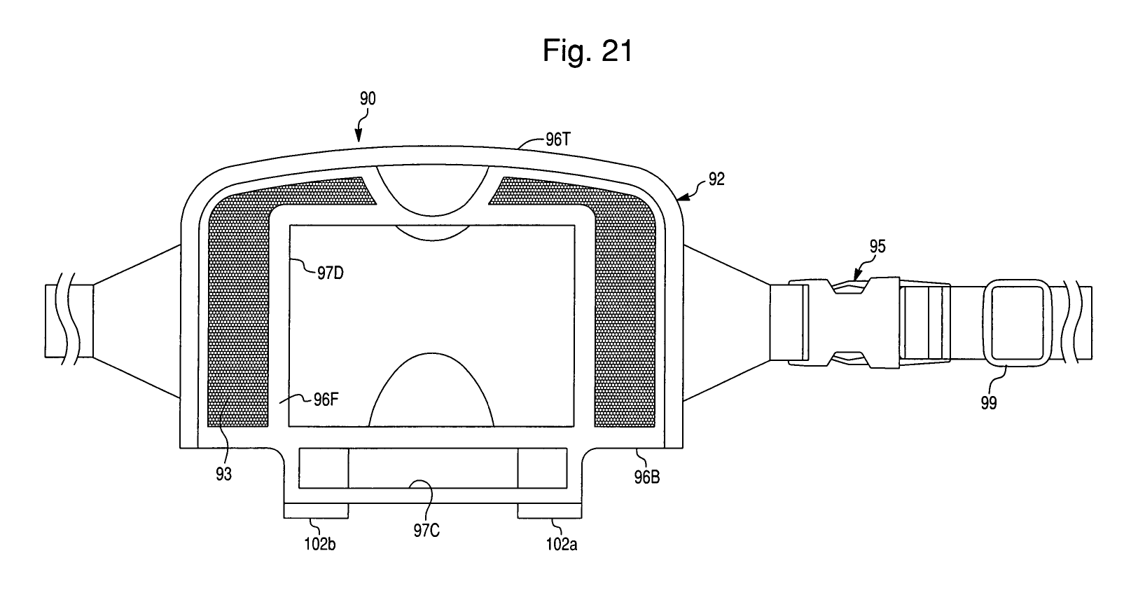

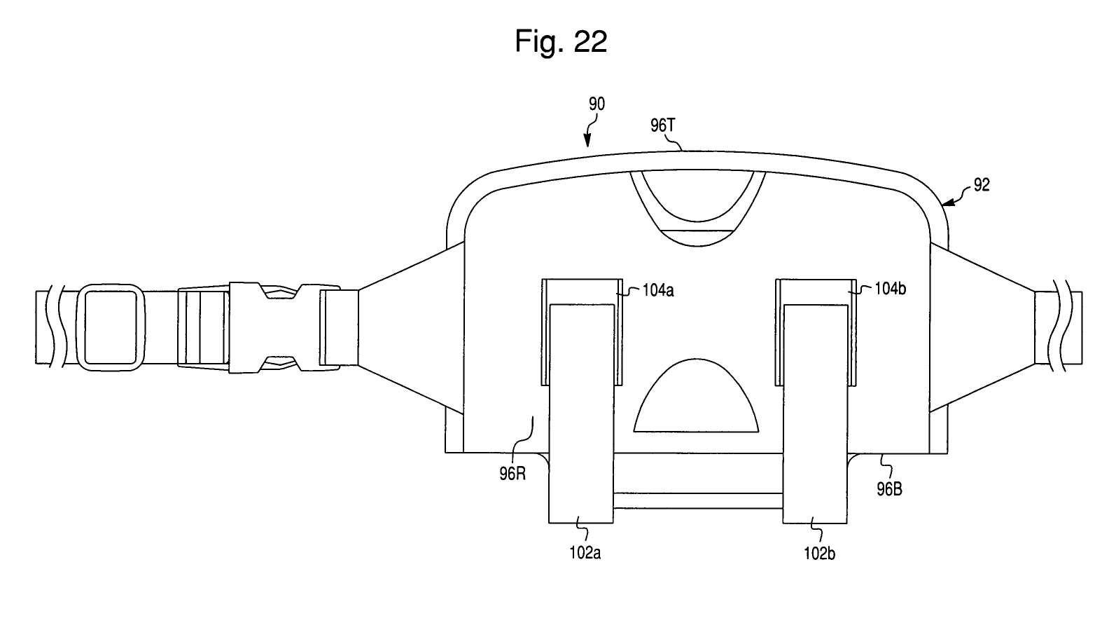

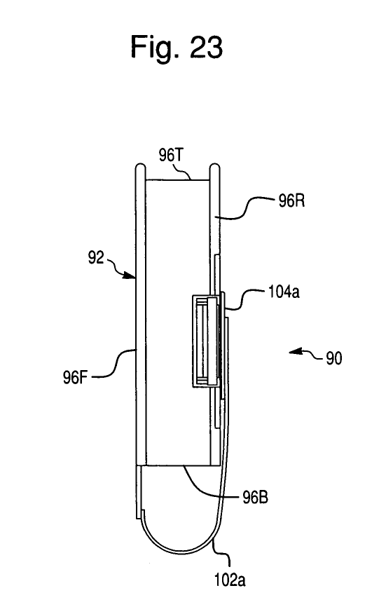

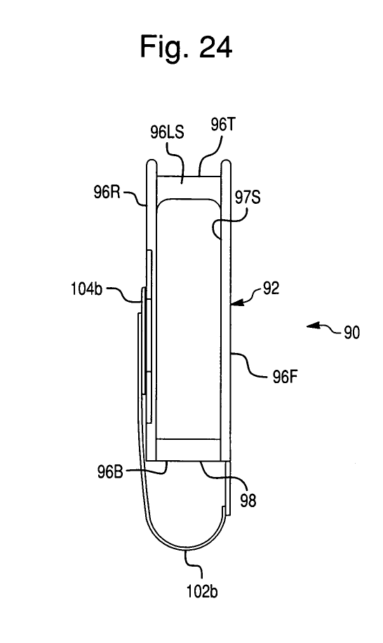

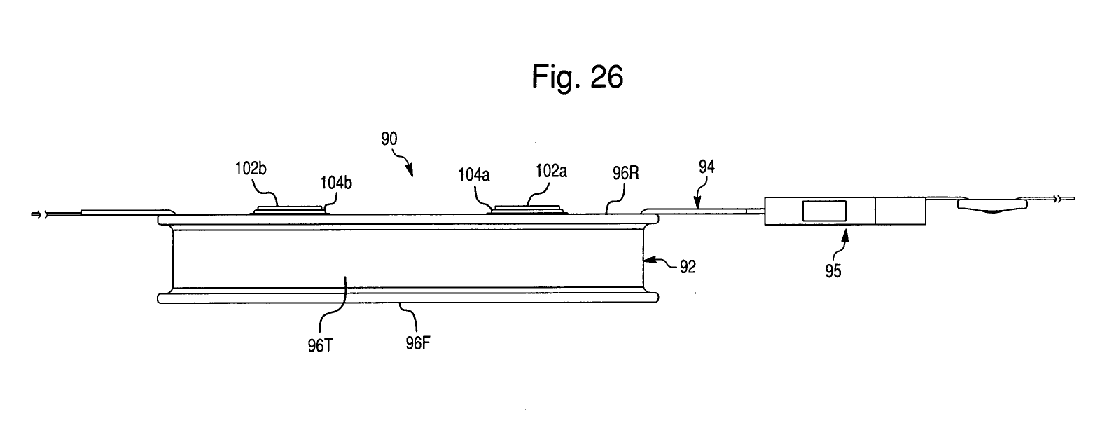

Accompanying drawings illustrate a preferred embodiment of a mounting kit for releassably (or removably) securing a portable video player assembly 5 and a detachable display unit 30 of the video player assembly 5 to a vehicle seat 1. The mounting kit of the present invention comprises a mounting system 71 and a display harness system 90. The mounting system 71 illustrated in FIG. 16, is provided for carrying and securely attaching the video player assembly 5 to the vehicle seat 1. In turn, the display harness system 90 illustrated in FIGS. 20A-26 is provided for carrying and releasably mounting a detachable display unit 30 independent of the video player assembly 5 to the vehicle seat 1.

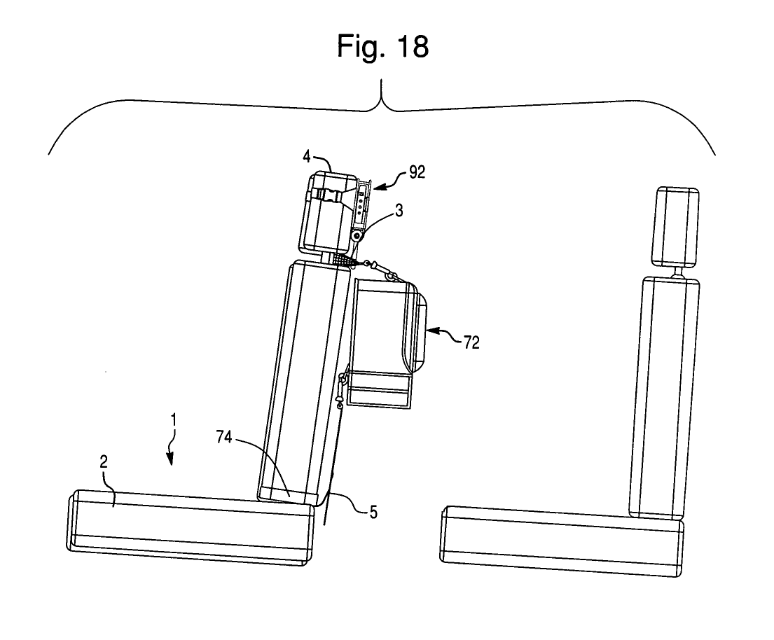

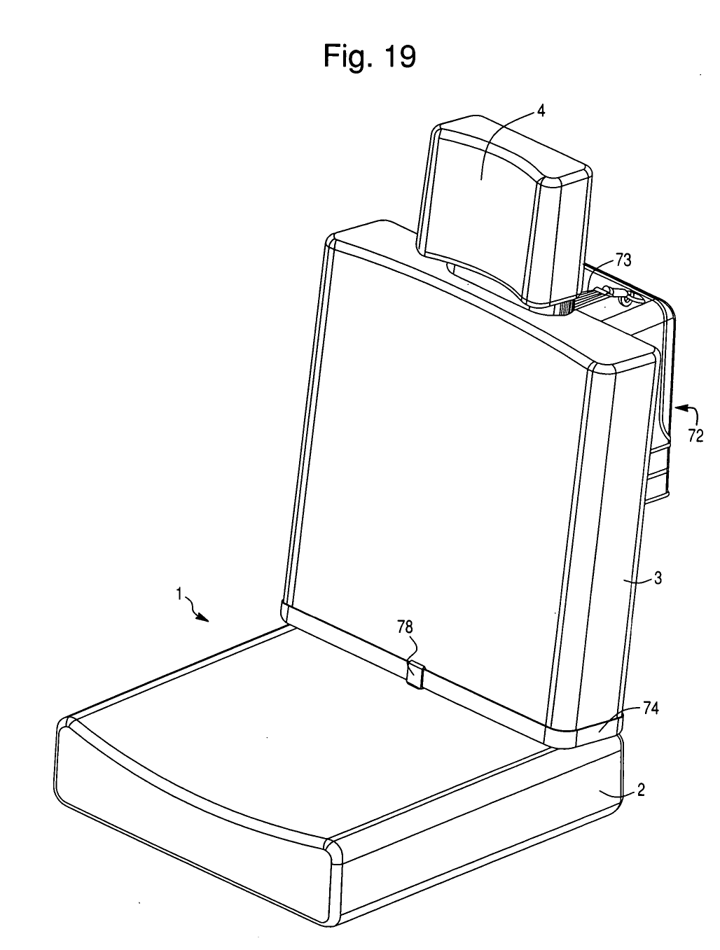

As shown in FIGS. 18 and 19, the vehicle seat 1 includes a substantially horizontal bench portion 2, a backrest portion 3 and a headrest 4 extending from the backrest portion 3. Preferably, the mounting system 71 is provided for securely attaching the video player assembly 5 to the backrest portion 3 of the vehicle seat 1, while the harness system 90 is provided for mounting the detachable display unit 30 independent of the video player assembly 5 to the headrest 4 of vehicle seat 1.

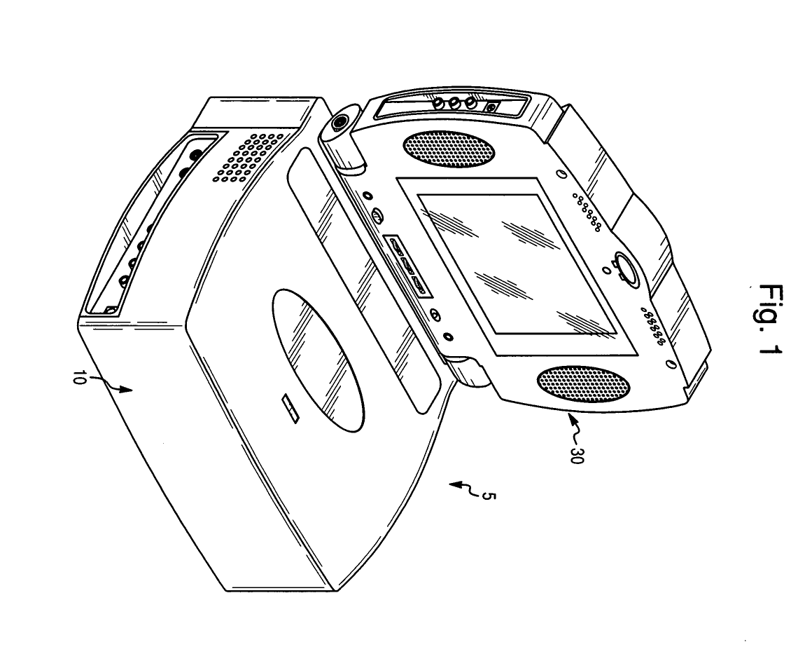

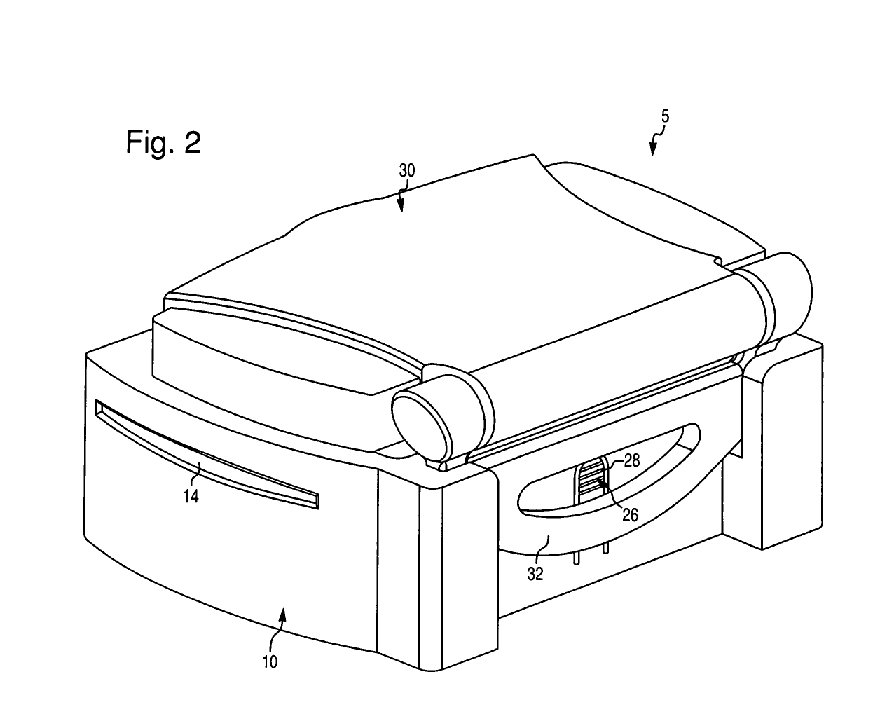

FIGS. 1 and 2 of the drawings illustrate an exemplary embodiment of the video player assembly 5 comprising an electronic video player device, such as a digital video disc (DVD) player 10, and a separate video display unit 30 removably attached to the video player device 10. It will be appreciated that other appropriate electronic video player devices, such as video CD (VCD) players, VCRs, video game console, etc., are within the scope of the present invention. The video player assembly 5 is disclosed in detail in the pending U.S. patent application Ser. No. 10/864,802, filed Jun. 10, 2004, which is assigned to the assignee of the present application and is hereby incorporated by reference into the present application.

The video player device 10 is adapted for pivotally supporting the video display unit 30 between a stowed position (shown in FIG. 2) and a deployed position (shown in FIG. 1).

The video display unit 30 comprises a base member 32 adapted to be removably attached to the video player device 10, and a video display member 42 pivotally mounted on the base member 32, as illustrated in FIG. 7.

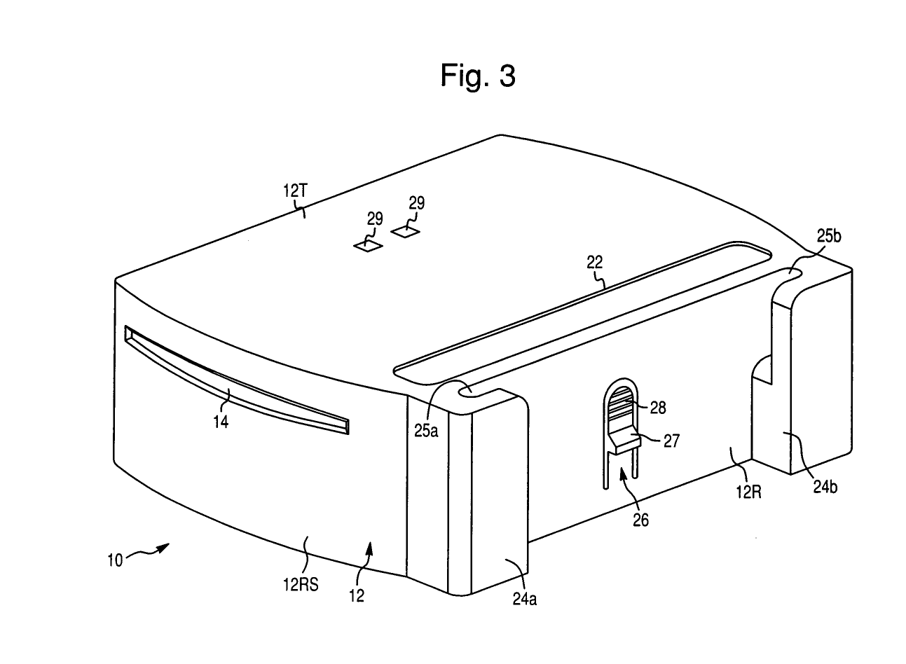

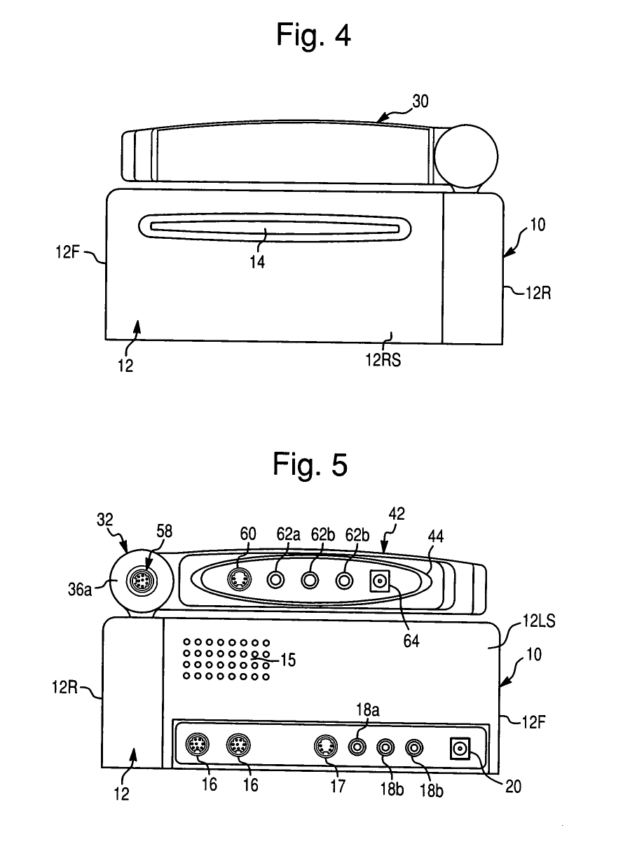

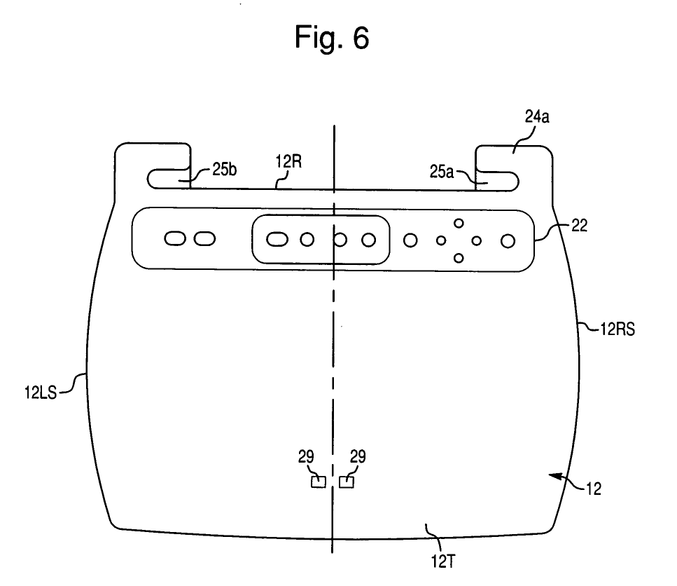

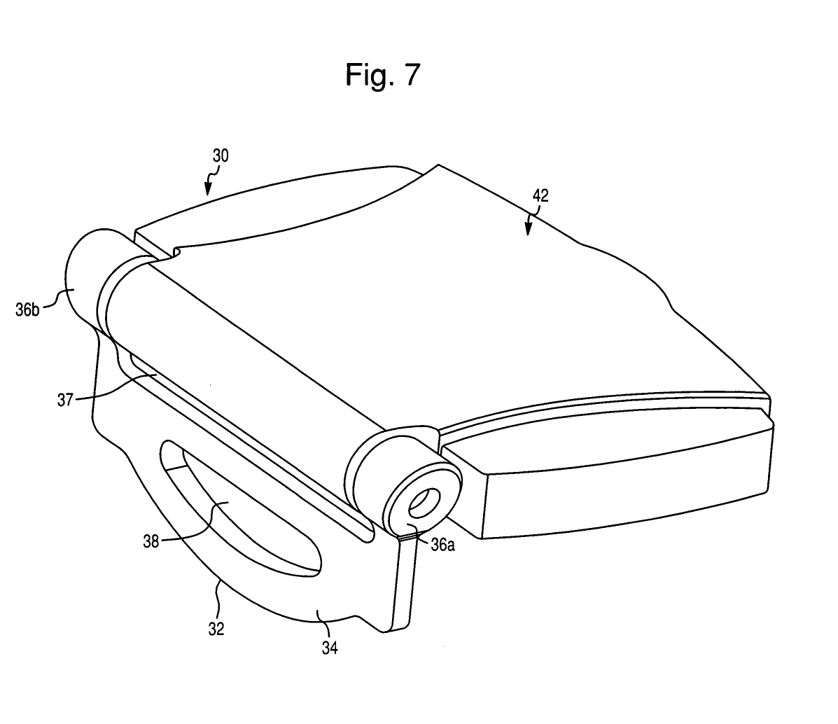

The video player device 10 of the exemplary embodiment of the present invention 20 illustrated in detail in FIGS. 3-6, includes a substantially box-like casing 12 having a top panel 12_{T} and a bottom panel, a front panel 12_{F}, a rear panel 12_{R}, and opposite side panels 12_{RS} and 12_{LS}. The right side panel 12_{RS} of the casing 12 is provided with a slot 14 for inserting digital video discs (DVDs), shown in FIG. 4. As illustrated in FIG. 5, the left side panel 12_{LS} of the casing 12 is provided with ventilating openings 15, two monitor connecting sockets 16, an S-video output socket 17, a video output socket 18a, two audio output sockets 18b and a socket 20 for a DC/AC adapter (not shown). The sockets 17, 18a and 18b define a DVD player electrical interface adapted to be operably connected to an electrical interface of the video display unit 30 and communicate electrical signals therebetween. The top panel 12_{T} of the casing 12 is substantially flat and includes a plurality of control buttons 22 provided to operate the DVD player device 10 and magnetic inserts 29, as shown in FIGS. 3 and 6.

Furthermore, the rear panel 12_{R} of the casing 12 has two opposite extensions 24a and 24b each forming an open support slot 25a and 25b, respectively, provided to receive the base member 32 of the video display unit 30 therein to support the video display member 42.

Moreover, as illustrated in FIGS. 2 and 3, the rear panel 12R of the casing 12 is provided with a release lever 26 including a locking tab 27 that engages a complementary recess formed in the base member 32 of the video display unit 30 to positively connect the video player device 10 to the base member 32 of the video display unit 30.

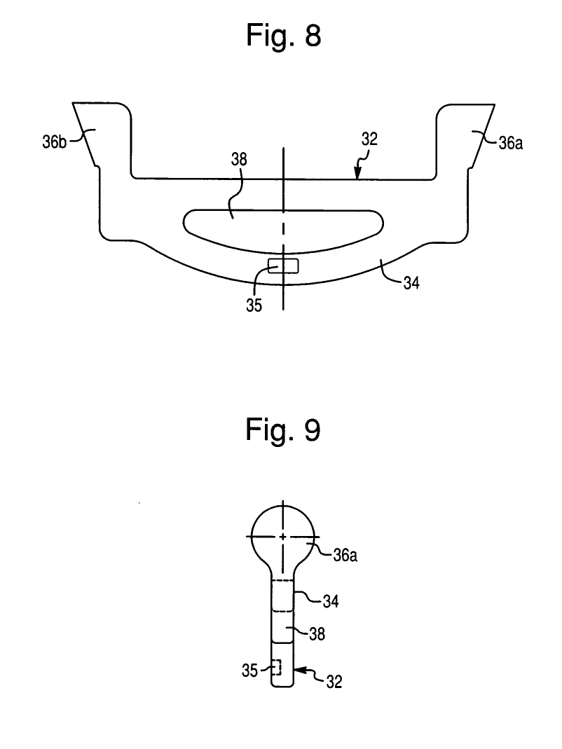

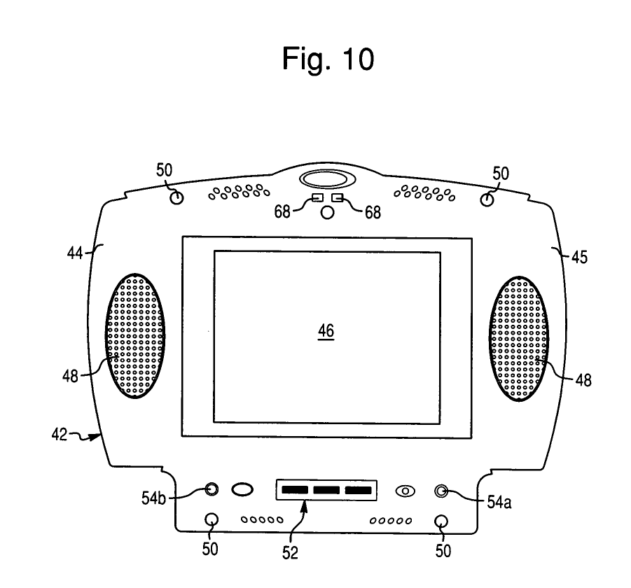

The base member 32 of the video display unit 30, illustrated in detail in FIG. 8, includes a stand portion 34 and a pair of hinge portions 36a and 36b formed at opposite ends of the stand portion 34. The stand portion 34 of the base member 32 has a through opening 38 configured so that provide an access to the button surface 28 of the release lever 26 when the video display unit 30 is attached to the video player device 10, as shown in FIGS. 2 and 10. The stand portion 34 is also provided with a locking recess 35 complementary to the locking tab 27 of the release lever 26 formed on the rear panel 12_{R} of the casing 12 of the video player device 10.

The video display member 42 of the video display unit 30, illustrated in detail in FIG. 10, includes a hollow display casing 44 made of, preferably, appropriate plastic material. The display casing 44 houses a display screen 46. Preferably, the display screen 46 is a substantially flat liquid crystal display (LCD) screen. The display casing 44 further houses a pair of built-in stereo speakers 48 located on both sides of the LCD screen 46 for providing a stereo sound. Also, a plurality (preferably four) of elastic, such as rubber, pad members 50 are provided on a viewing surface 45 of the display casing 44 adapted to provide a small clearance between the video display member 42 and the top panel 12_{T} of the player casing 12 when the video display unit 30 is in the stowed position. Moreover, the display casing 44 includes magnetic inserts 68 oriented so as to register with the magnetic inserts 29 on the top panel 12_{T} of the casing 12 when the video display unit 30 is in the stowed position. Thus, the magnetic inserts 29 and 68 act as a locking means for retaining the video display unit 30 is in the stowed position.

The display casing 44 also includes various audio and video controls 52 and a pair of stereo headphone jacks 54a and 54b. The display casing 44 may also include other controls and integration ports to allow the video player device 10 to connect and interface with multiple auxiliary devices.

As further illustrated in FIG. 5, the video display unit 30 is provided with an audio/video/power signal port 58 provided within the hinge portion 36a of the base member 32, an S-video input socket 60, a video input socket 62a, two audio input sockets 62b and a socket 64 for a DC/AC adapter (not shown) provided in the display casing 44 of the video display panel 42. The audio/video/power signal port 58 is adapted to be connected to one of the monitor connecting sockets 16 of the video player device 10 via an electric cable (not shown). Preferably, a single cable is employed to form an all-in-one connection (video, audio L/R, voltage source, etc.) to increase the ease in which the video display unit 30 may be manipulated independently of the video player device 10. Additional audio/video sockets 60, 62a and 62b define the electrical interface of the video display unit 30 adapted to be operably connected to the electrical interface of the video player device 10 and communicate electrical signals therebetween to provide independent connection to any video player device.

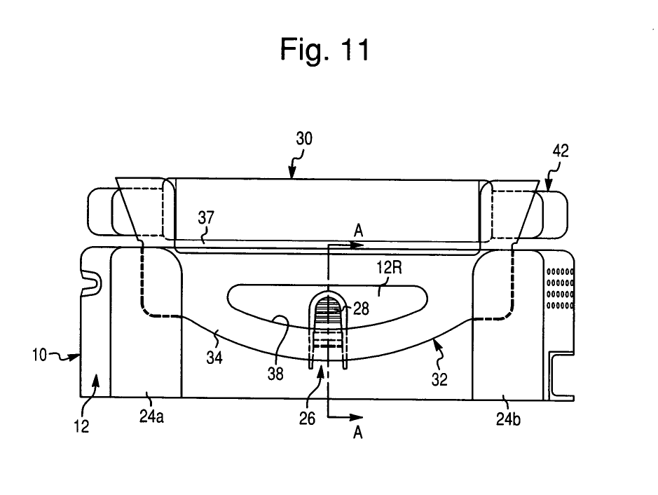

As shown in FIGS. 7 and 11, a lower end of the display casing 44 is pivotally mounted to the hinge portions 36a and 36b of the base member 32 through a continuous resistance device. The pivotal connection allows the video display member 42 to pivot at least 180° relative to the base member 32. A latch mechanism includes the cantilevered release lever 26 provided with the locking tab 27 to engage the locking recess 35 in the stand portion 34 of the base member 32, thus providing releasable connection between the video player device 10 and the video display unit 30.

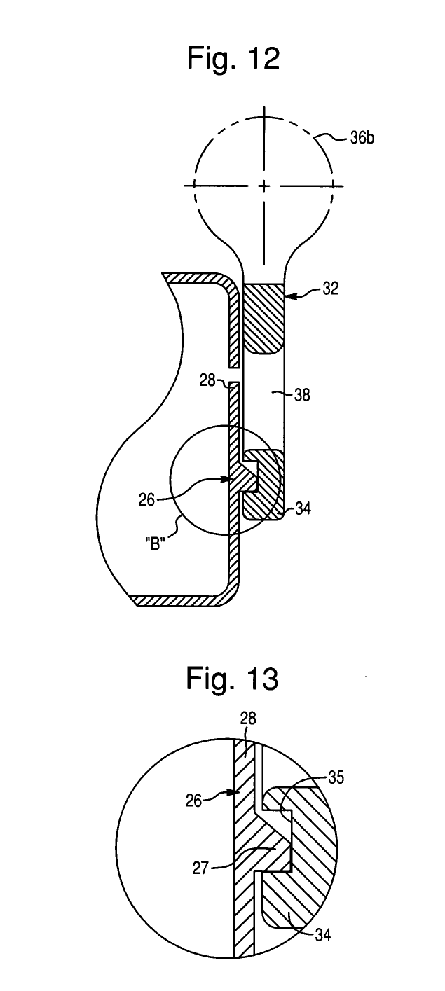

As best shown in FIGS. 2 and 11, when the video display unit 30 is attached to the video player device 10, opposite end portions of the stand portion 34 of the base member 32 are disposed in the support slots 25a and 25b formed in the extensions 24a and 24b of the casing 12 of the video player device 10. In the installed position, the locking tab 27 of the cantilevered release lever 26 positively engages the locking recess 35 in the stand portion 34 of the base member 32 as illustrated in FIGS. 12 and 13, thus firmly securing the video display unit 30 to the video player device 10.

A user can easily disengage the video display unit 30 from the video player device 10 by simply depressing the ribbed button surface 28 of the release lever 26 by his finger (as the button surface 28 is accessible through the through opening 38 in the stand portion 34) to bend the release lever 26 away from the stand portion 34 of the base member 32 into the casing 12 of the video player device 10. This action disengages the locking tab 27 from the locking recess 35 in the stand portion 34 of the base member 32. At the same time, the user should lift the stand portion 34 upward to slide the base member 32 out of the support slots 25a and 25b in the casing 12 of the video player device 10.

If the user intends to leave the video display unit 30 attached to the video player device 10, the video display member 42 can be pivoted downward so that the video display member 42 is oriented downward adjacent to the top panel 12_{T} of the video player device 10 in the stowed position (shown in FIG. 2), or the video display member 42 can be pivoted upward so that the video display member 42 projects outwardly from the top panel 12_{T} of the video player device 10 in the deployed position (shown in FIG. 1) wherein the display screen 46 is viewable by the user of the video player assembly.

The video display unit 30 may be electronically connected to the video player device 10 by any method known in the art, such as by a single cable bundle connected through a single audio/video port in each of the video display unit 30 and the video player device 10. Such electronic connections are well within the knowledge of one of ordinary skill in the art and need not be elaborated further. The audio/video signal is thus transmitted to the video display unit 30. The video display unit 30 includes conventional circuitry and components to display the video images and broadcast audio. The video display member 42 includes associated audio and video controls 52 on the display casing 44 to adjust the display screen 46 and speaker volume. Such video display member 42 may include LCD display screen. However it is to be understood that any display device capable of displaying vide signals may be employed. An independent power supply may be employed to power the video display member 42 or a battery compartment may be provided.

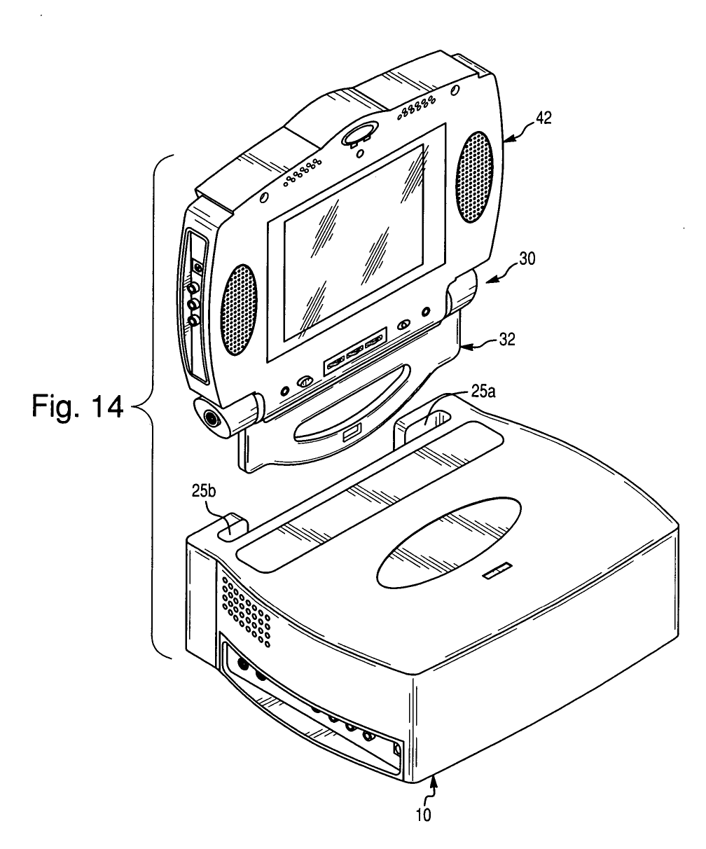

In operation, a user simply inserts the opposite end portions of the stand portion 34 of the base member 32 into the support slots 25a and 25b formed in the extensions 24a and 24b of the casing 12 of the video player device 10, as illustrated in FIG. 14. The stand portion 34 is dimensioned to fit in the support slots 25a and 25b formed in the extensions 24a and 24b of the casing 12. The front surface of the stand portion 34 substantially conforms to a corresponding portion of the rear panel 12_{R} of the player casing 12 such that the two surfaces rest substantially flush against one another when connected. The locking tab 27 of the cantilevered release lever 26 projects outward from the rear panel 12_{R} of the casing 12 such that as the base member 32 is inserted into the support slots 25a and 25b, the cantilevered release lever 26 is forced backwards until the locking tab 27 engages the corresponding locking recess 35. When the stand portion 34 of the base member 32 is inserted sufficiently into the support slots 25a and 25b, the cantilevered release lever 26 springs back due to the resiliency thereof and the locking tab 27 engages the locking recess 35. The overall arrangement provides a snug snap fit releasable connection between the video display unit 30 and the video player device 10.

The video display member 42 may then be adjusted to pivot between the stowed position whereby the display member 42 rests substantially flush against the top panel 12_{T} of the video player device 10, and the deployed position suitable to be viewed by the user by manipulating the pivotal connection between the lower end of the video display member 42 and the base member 32. When the video display member 42 is stored flush against the top panel 12_{T} of the video player device 10, the arrangement of the present invention provides a compact complete portable video player assembly.

As indicated above, the rotatable (pivotal) connection between the base member 32 and the video display member 42 of the video display unit 30 includes the continuous resistance device that requires a threshold force to rotate the video display member 42 relative to the base member 32, thus allowing the video display member 42 to be infinitely adjustable between various angular positions between the stored position and an open position. Preferably, the video display member 42 may be rotated in excess of 180°.

To release the video display unit 30 from the separate video player device 10, the user simply inserts a finger within the through opening 38 in the stand portion 34 of the base member 32, depresses the ribbed button surface 28 of the release lever 26 by his finger to bend the release lever 26 away from the stand portion 34 of the base member 32 into the casing 12 of the video player device 10 and force the locking tab 27 out of the corresponding locking recess 35 in the stand portion 34 of the base member 32. The video display unit 30 may then be simply pulled out of the support slots 25a and 25b in the casing 12 and thereby detached from the video player device 10. The overall arrangement provides a detachable yet secure connection between the video display unit 30 and the video player device 10 to positively retain the video display unit 30 to the video player device 10.

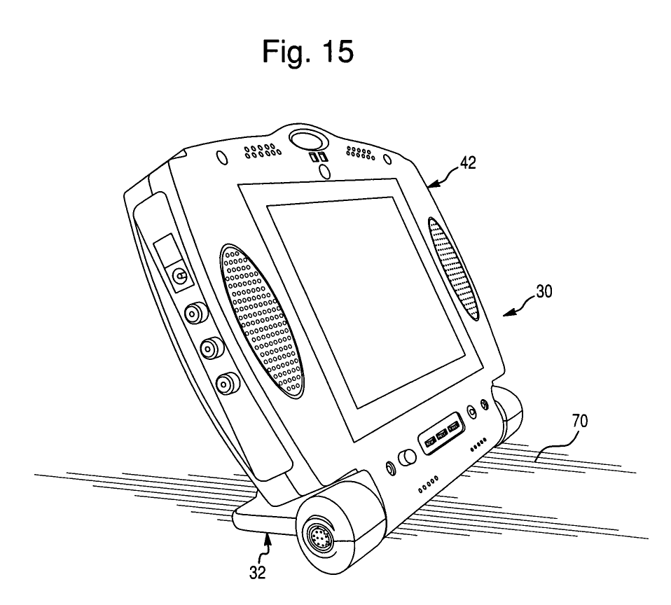

Moreover, the present invention allows the video display unit 30 to be removed from the video player device 10 and independently supported on any substantially flat surface. As illustrated in FIG. 15, the base member 32 is adjusted relative to the video display member 42 to an angular position allowing the base member 32 to independently support the video display member 42 on a substantially flat surface 70. In other words, when the base member 32 is rotated backward, away from the viewing surface of the video display member 42, the base member 32 may function as an independent stand for the video display member 42 of the video display unit 30, as shown in FIG. 15.

While the present invention is described in relation to the DVD player, the invention is equally suited for use with other electronic video player devices, such as CVD and VCR players, video game consoles and other similar processing units producing an electronic video signal. Although the materials of construction are not described, they may include a variety of compositions consistent with the function of the invention.

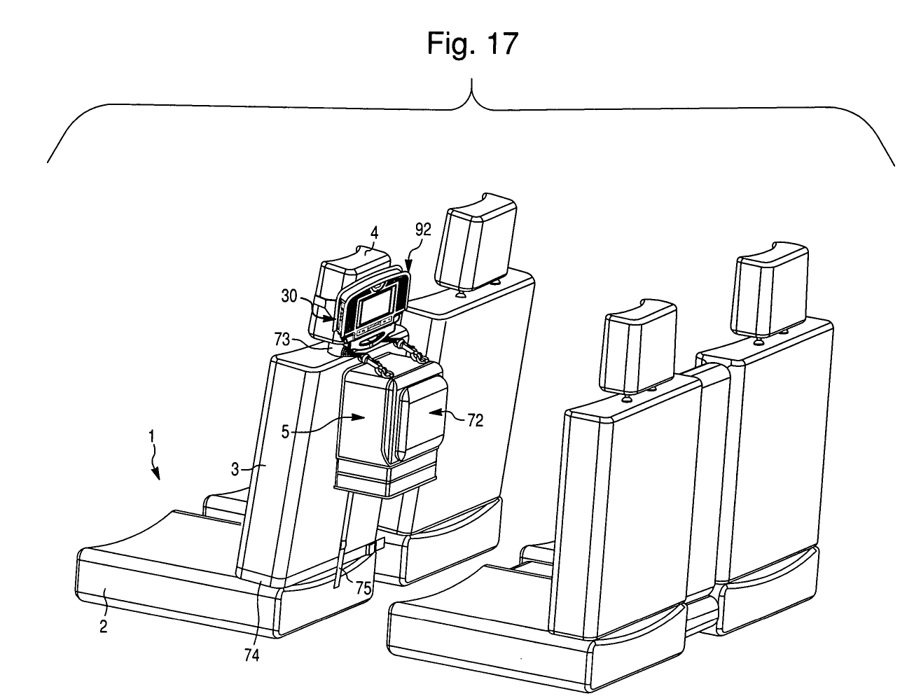

FIGS. 17-19 depict the mounting system 71 of the present invention as installed on the vehicle seat 1. The mounting system 71 is disclosed in detail in the pending U.S. patent application Ser. No. 10/673,632, filed Sep. 30, 2003, which is assigned to the assignee of the present application and is hereby incorporated by reference into the present application.

The mounting system 71 comprises a bag 72 provided for carrying the video player assembly 5 and a bag harness system provided for securely attaching the video player assembly 5 to the backrest portion 3 of the vehicle seat 1. The bag harness system is comprised of a headrest strap 73, which secures the bag 72 to the headrest 4 of the vehicle seat 1, and a base strap 74, which encompasses a base of the backrest portion 3 of the vehicle seat 1. The base strap 74 is connected to the bag 72, by a crossover strap 75. The crossover strap 75 maintains the bag 72 in a centered position, and ensures that the bag 72 is securely anchored to prevent relative motion between the seat 1 and the portable video player assembly 5.

As best illustrated in FIGS. 17-19, the crossover strap 75 runs between the backrest portion 3 and the bench portion 2 of the seat 1, and is connected to the base strap 74, on the front side of the seat 1 by a sliding strap loop 78. The sliding strap loop 78 allows the attachment between the crossover strap 75 and the base strap 74 to be adjusted to conform to the width of the seat 1. The sliding strap loop 78 also allows the crossover strap 75 to be positioned at any horizontal point on the base strap 74.

The opposite end of the crossover strap 74 is connected to the bag 72. The bag 72 includes connecting hardware that can be of any type known in the art, but is preferably a D-ring 79. The end of the crossover strap 74 designed to connect with the bag D-ring 79 has an appropriate linking connector, preferably a bolt snap connector 80. The bolt snap connector 80 hooks into the D-ring 79 to form a secure connection between the crossover strap 75 and the bag 72, while the crossover strap 75 functionally ensures a secure connection between the base strap 74 and the bag 72.

At the mid-point of the crossover strap 75, there is an adjustment mechanism 81, which allows the length of the crossover strap to be adjusted to conform to varying seat types. The headrest strap 73 includes a similar adjustment mechanism 85 that allows the length of the headrest strap 73 to be adjusted. One end of the base strap 74 also has an adjustment mechanism 82 that allows the length of the base strap to be adjusted. Although the adjustment mechanisms 81, 82, 85, may be of any type known in the art, they are preferably, slide buckle type mechanisms.

Similar to the attachment point between the crossover strap 75 and the bag 72, the connection system between the bag 72 and headrest strap 73 is also designed to be secure and convenient. The connection system may be of any type known in the art, but is preferably a D-ring and bolt snap system. As best shown in FIG. 1, the bag 72 has two D-ring-type connectors 83 positioned on a top surface of the bag 72, and the headrest strap 73 has two bolt snap connectors 84 disposed at each end of the strap 73. The bolt snap connectors 84 hook into the D-rings 83 to form a secure connection between the headrest strap 33 and the bag 72.

For the foregoing reasons, it is clear that the invention provides an improved system for firmly and efficiently securing a bag containing a portable electronic device to an interior component of an automobile. The invention comprises a three-point attachment system that allows the associated bag to be removed quickly and conveniently removed at any time.

Multiple variations and alternative embodiments are clearly apparent to one of ordinary skill in the art. For example, although only bucket-type seats are shown in the drawings, the base strap 74 may be lengthened to accommodate conventional bench-type seats. Similarly, the base strap 74 is described as encircling the base of the backrest portion 3, the base strap 74 may alternatively encircle the bench portion 2 of the seat 1, or the vertical support members (not shown) that attach the seat 1 to a floor of the vehicle. Depending on the application, the base strap 74 may be omitted completely, and the crossover strap 75 may be attached directly to a seat component, or an anchor support on the floor. The crossover strap 75 may also be omitted completely, and the headrest strap 73 combined to converge into a single point of attachment, and deployed either alone or in combination with at least one crossover strap. Alternatively, additional straps may be added to the preferred three-strap embodiment to further stabilize the bag.

Similarly, the headrest strap 73 may be attached to the ceiling or another anchoring component functionally capable of supporting the bag 72. The headrest strap 73 may also encircle both headrests/upper seat portions 4 (rather than just one), and the base strap 74 could encircle two individual seats, thereby positioning the bag 1 between the seats 1. In this position, the base strap 74 could instead encircle the console, or attach to an alternative anchoring component, rather than encircling the seat(s) 1.

Although the invention has been primarily described as attaching a portable electronic device to an automobile seat, the invention may attach the portable electronic device to any type of seat, including stationary (non-vehicle) seats, airline seats, train seats, boat seats, etc. The invention may also be attached to stationary furniture, or any other object or feature functionally capable of supporting the bag.

Although the materials of construction have not been described, they may include any type of material that can perform the function of the component as described. For example, the bag 72 may be comprised of a relatively soft material such as nylon, fabric, vinyl, leather, rubber, soft plastic, etc., or the bag 72 may be a hard case comprised of metal, fiberglass, hard plastic, or the like. Further, it is within the scope of the invention for there to be no conventional “bag” at all, if the portable electronic device has the connecting hardware incorporated into its design. The straps described in the invention may be elasticized or non-elasticized, and may be comprised of nylon, fabric, vinyl, leather, rubber, plastic, or any other material capable of performing the function. Similarly, as noted supra, the connection mechanisms and hardware may be of any type known in the art. Such variations are not to be regarded as a departure from the spirit and scope of the invention, and all such modifications as would be obvious to one skilled in the art are intended to be included within the scope of the following claims.

FIGS. 20A-26 depict the display harness system 90 of the preferred embodiment of the present invention. The display harness system 90 comprises a display case 92 provided for housing and carrying the detachable display unit 30 independent of the video player assembly 5, and a flexible, adjustable mounting strap 94 attached to the display case 92 and provided for securely attaching the display unit 30 to the backrest portion 3 or the headrest 4 of the vehicle seat 1.

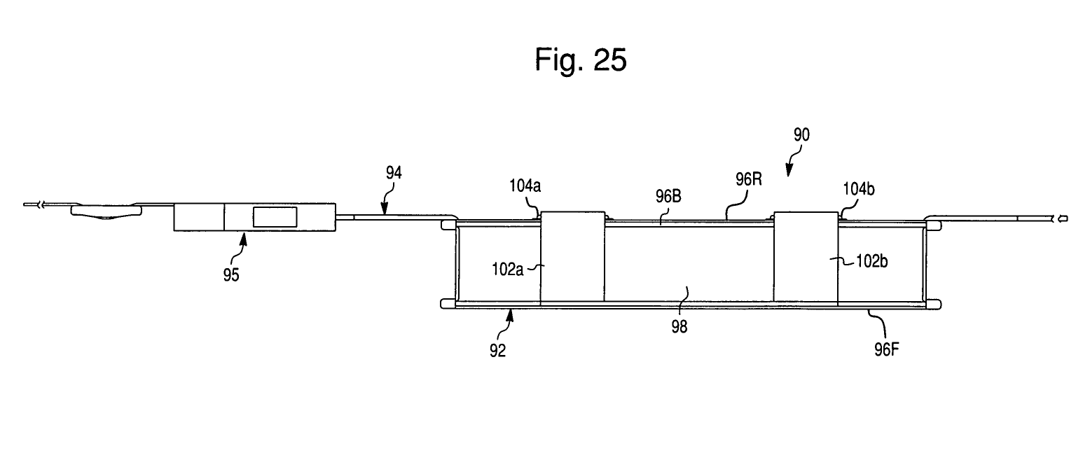

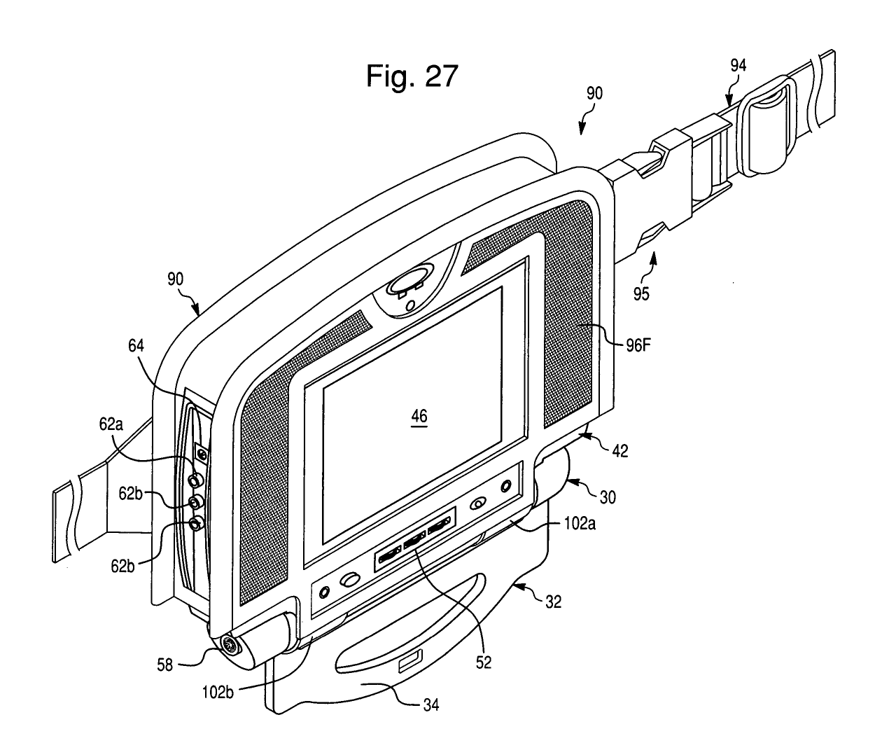

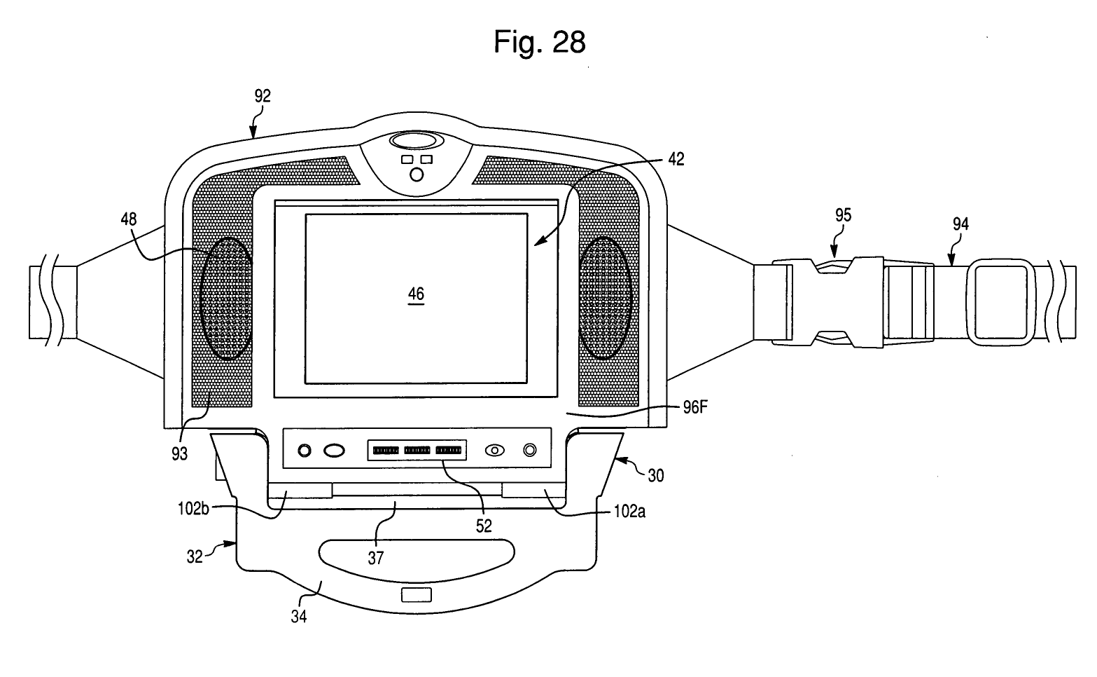

The display case 92 includes a front side 96F, a rear side 96R and a bottom side 96B. The bottom side 96B of the display case 92 defines an opening 98 (better seen in FIGS. 20 and 25) provided for receiving the display unit 30 within the display case 92. More specifically, the display unit 30 is positioned within the display case 92 so that the base member 32 thereof extends from the display case 92, as illustrated in FIGS. 27 and 28.

The front side 96F of the display case 92 has a generally rectangular display opening 97D to permit viewing of the display screen 46 of the video display member 42. The front side 96F further has a generally rectangular control panel opening 97C to permit access to the various audio and video controls 52 and the stereo headphone jacks 54a and 54b. A left side surface 96LS of the display case 92 has a generally rectangular display opening 97S to permit access to various input sockets of the video display unit 30 when the latter is disposed within the display case 92, such as the video input socket 62a, the audio input sockets 62b and the socket 64. Preferably, the front side 96F of the display case 92 is made of a screen mesh material 93 to expose the pair of the built-in stereo speakers 48 located on both sides of the display screen 46. Alternatively, the front side 96F of the display case 92 may be provided with specific speaker openings to expose the speakers 48.

The display case 92 further includes a retainer 100 provided for releasably securing the display unit 30 within the display case 92 so that base member 32 of the video display unit 30 extends from the display case 92. According to the preferred embodiment of the present invention, the retainer 100 includes a pair of flexible retainer straps 102a and 102b extending between the front side 96F and the rear side 96R of the display case 92 for releasably retaining the video display member 42 of the display unit 30 within the display case 92. Preferably, as illustrated in FIGS. 20-23, a proximal end of each of the flexible retainer straps 102a and 102b is secured to the front side 96F of the display case 92, while a distal end thereof is provided with a hook and loop (Velcro) material provided to be releasably attached to a complementary patch of a hook and loop (Velcro) material (104a and 104b, respectively) secured to the rear side 96R of the display case 92. Alternatively, the proximal ends of the retainer straps 102a and 102b may be fixed to the rear side 96R of the display case 92, while the patches of the Velcro material (104a and 104b, respectively) provided to the front side 96F of the display case 92. It will be appreciated that any other appropriate releasable fasteners, such as quick release or snap fasteners, may be employed. It will be further appreciated.

As illustrated in FIGS. 27 and 28, when the display unit 30 is disposed within the display case 92, the flexible Velcro retainer straps 102a and 102b extend between the front side 96F and the rear side 96R of the display case 92 through a clearance 37 (shown in FIGS. 7, 11 and 28) between the video display member 42 and the base member 32 of the display unit 30.

The mounting strap 94 is arranged substantially horizontally and is capable of attaching the display case 92 to the headrest 4 of the vehicle seat 1, as illustrated in Fig. The mounting strap 94 has a strap length adjusting device provided for selectively adjusting a length of the mounting strap 94, whereby a circumference of the mounting strap 94 can be changed. Preferably, the adjusting device is in the form of a slide buckle 99. The mounting strap 94 is fixed (e.g. sewn) to the rear side 96R of the display case 92. The mounting strap 94 further includes a quick release coupler 95 for releasably securing the mounting strap 94 and the display case 92 to the headrest 4 of the vehicle seat 1.

In operation, if a consumer wishes to use the display unit 30 independently (or separately) of the video player assembly 5, the display unit 30 is detached from the video player device 10 and inserted into the display case 92 trough the opening 98 in the bottom side 96B thereof. Then, the flexible Velcro retainer straps 102a and 102b are pulled through the clearance 37 between the video display member 42 and the base member 32 of the display unit 30. Subsequently, the flexible Velcro retainer straps 102a and 102b are wrapped around a bottom portion of the video display member 42 and the distal ends of the flexible Velcro retainer straps 102a and 102b are attached to the Velcro patches 104a and 104b, respectively, thus positively retaining and releasably securing the display unit 30 within the display case 92, as illustrated in FIGS. 27 and 28. Next, the quick release coupler 95 of the mounting strap 94 is opened, the mounting strap 94 is wrapped about the headrest 3, then the quick release coupler 95 is re-closed, thus releasably attaching the display unit 30 to the vehicle seat 1 (such as the headrest 4 or an upper portion of the backrest portion 3) independently of the video player device 10. This facilitates enjoyable viewing by a rear occupant of a vehicle. The video player device 10 may then be stored in various remote positions, such as a vehicle floor, under the seat, etc., thus placing the display unit 30 in more convenient location and increasing the space between the rear occupant and the front seat.

Although the materials of construction of the display case 92 have not been described, they may include any type of material that can perform the function of the component as described. For example, the display case 92 may be comprised of a relatively soft material such as nylon, fabric, vinyl, leather, rubber, soft plastic, etc., or the display case 92 may be a hard case comprised of metal, fiberglass, hard plastic, or the like.

The description of the preferred embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1. A combination of a video display unit and a display harness system for releasably mounting the video display unit to a vehicle seat, said video display unit detachably mounted to a video player device, said video display unit including a video display member pivotally mounted to a base member, said display harness system comprising:
a display case releasably attachable to the headrest, said display case provided for housing said video display member within said display case, said display case having a front side, a rear side, and a bottom side; and
a mounting strap attached to said display case for releasably attaching said video display unit to the vehicle seat;
said bottom side of said display case defining an opening provided for receiving said video display member of said display unit within said display casing;
said display case having a retainer provided for releasably securing said video display member within said display case so that said base member of said video display unit extends from said display case.

2. The combination as defined in claim 1, wherein said front side of said display case has a substantially rectangular display opening to permit viewing of the display screen of the video display member.

3. The combination as defined in claim 1, wherein said front side of said display case has a substantially rectangular control panel opening to permit access to various audio and video controls of the video display member.

4. The combination as defined in claim 3, wherein said control panel opening is further provided to permit access to stereo headphone jacks formed on the video display member.

5. The combination as defined in claim 1, wherein said front side of said display case is made of a screen mesh material to expose a pair of built-in stereo speakers of the video display member.

6. The combination as defined in claim 1, wherein said retainer is in the form of at least one flexible retainer strap extending between a front side and a rear side of said display case.

7. The combination as defined in claim 6, wherein said at least one retainer strap has a proximal end fixed to one of said front side and said rear side of said display case, and a distal end releasably attachable to the other one of said front side and said rear side of said display case.

8. The combination as defined in claim 7, wherein said distal end of said at least one retainer strap is provided with a Velcro material provided to be releasably attached to a complementary patch of Velcro material.

9. The combination as defined in claim 6, wherein said at least one flexible retainer strap extends trough a clearance between the video display member and the base member of the video display unit.

10. The combination as defined in claim 6, wherein said at least one flexible retainer strap includes a pair of substantially identical flexible retainer strap.

11. The combination as defined in claim 1, wherein said mounting strap has a strap length adjusting device provided for selectively adjusting a length of said mounting strap, whereby a circumference of said mounting strap can be changed.

12. The combination as defined in claim 11, wherein said adjusting device is a slide buckle.

13. The combination as defined in claim 1, wherein said mounting strap includes a quick connect device for releasably engaging the headrest of the vehicle seat.

14. A combination of a portable video player device including a portable video player device and a video display unit detachably mounted thereto and a mounting kit for removably securing at least one of said portable video player device and said video display unit to a vehicle seat, said video display unit including a video display member pivotally mounted to a base member, said mounting kit comprising:
a player mounting system provided for carrying and securely attaching the video player device to the vehicle seat; and
a display harness system for carrying and releasably mounting the video display unit to the vehicle seat independent of the video player device;
said display harness system including:
a display case releasably attachable to the headrest, said display case provided for housing said video display member within said display case, said display case having a front side, a rear side, and a bottom side; and
a mounting strap attached to said display case for releasably attaching said video display unit to the vehicle seat;
said bottom side of said display case defining an opening provided for receiving said video display member of said display unit within said display casing;
said display case having a retainer provided for releasably securing said video display member within said display case so that said base member of said video display unit extends from said display case.

15. The combination as defined in claim 14, wherein the vehicle seat has a bench portion, a backrest portion and a headrest extending from the backrest portion; and wherein said player mounting system includes:
a bag adapted for accessibly retaining said portable video player device;
a headrest strap substantially encircling an upper portion of the backrest portion of the seat and connected to an upper portion of said bag; and
a base strap substantially encircling a lower portion of the seat proximate said bench portion thereof and connected to a lower portion of said bag.

16. The combination as defined in claim 15, wherein said headrest strap is connected to two discrete spaced apart points in said upper portion of said bag.

17. The combination as defined in claim 15, wherein said base strap is connected to said base at a single point.

18. The combination as defined in claim 16, wherein said base strap is connected to said bag at a single point.

19. The combination as defined in claim 14, further comprising a crossover strap disposed between and interconnecting said bag to said base strap, wherein a first end of said crossover strap includes a sliding strap loop to providing an adjustable connection to said base strap.

20. The combination as defined in claim 14, wherein said crossover strap has an adjustment mechanism to adjust a length thereof.

21. The combination as defined in claim 20, wherein said adjustment mechanism is a slide buckle.

22. The combination as defined in claim 14, wherein said bag is a soft-sided bag.

23. The combination as defined in claim 14, wherein said headrest strap and said base strap each have an individual adjustment mechanism to adjust a length thereof.

24. A display harness system for removably mounting a video display unit to a vehicle seat, said video display unit including a video display member pivotally mounted to a base member, said display harness system comprising:
a display case removably attachable to the headrest, said display case provided for housing said video display member within said display case, said display case having a front side, a rear side, and a bottom side; and
a mounting strap attached to said display case for removably attaching said video display unit to the vehicle seat;
said bottom side of said display case defining an opening provided for receiving said video display member of said display unit within said display casing;
said display case having a retainer provided for removably securing said video display member within said display case so that said base member of said video display unit extends from said display case.

25. The display harness system as defined in claim 24, wherein said front side of said display case has a substantially rectangular display opening to permit viewing of the display screen of the video display member.

26. The display harness system as defined in claim 24, wherein said front side of said display case has a substantially rectangular control panel opening to permit access to various audio and video controls of the video display member.

27. The display harness system as defined in claim 26, wherein said control panel opening is further provided to permit access to stereo headphone jacks formed on the video display member.

28. The display harness system as defined in claim 24, wherein said front side of said display case is made of a screen mesh material to expose a pair of built-in stereo speakers of the video display member.

29. The display harness system as defined in claim 24, wherein said retainer is in the form of at least one flexible retainer strap extending between a front side and a rear side of said display case.

30. The display harness system as defined in claim 29, wherein said at least one retainer strap has a proximal end fixed to one of said front side and said rear side of said display case, and a distal end releasably attachable to the other one of said front side and said rear side of said display case.

31. The display harness system as defined in claim 30, wherein said distal end of said at least one retainer strap is provided with a Velcro material provided to be releasably attached to a complementary patch of Velcro material.

32. The display harness system as defined in claim 29, wherein said at least one flexible retainer strap extends trough a clearance between the video display member and the base member of the video display unit.

33. The display harness system as defined in claim 29, wherein said at least one flexible retainer strap includes a pair of substantially identical flexible retainer strap.

34. The display harness system as defined in claim 24, wherein said mounting strap has a strap length adjusting device provided for selectively adjusting a length of said mounting strap, whereby a circumference of said mounting strap can be changed.

35. The display harness system as defined in claim 34, wherein said adjusting device is a slide buckle.

36. The display harness system as defined in claim 24, wherein said mounting strap includes a quick connect device for releasably engaging the headrest of the vehicle seat.
